(19) United States
(12) Patent Application Publication
(10) Pub. No.: US 2025/0293362 A1
(43) Pub. Date: Sep. 18, 2025

(54) POWER STORAGE APPARATUS

(71) Applicant: TOYOTA JIDOSHA KABUSHIKI KAISHA, Aichi-ken (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Yuji KATAYAMA, Okazaki-shi (JP); Masaya OGURA, Hamamatsu-shi (JP); Ryutaro SUZUKI, Hamamatsu-shi (JP)

(21) Appl. No.: 19/056,742

(22) Filed: Feb. 19, 2025

(30) Foreign Application Priority Data
Mar. 13, 2024 (JP) 2024-039081

(51) Int. Cl. H01M 50/204; H01M 50/224; H01M 50/291; H01M 50/548; H01M 50/552; H01M 50/593

(52) U.S. Cl. CPC H01M 50/204; H01M 50/224; H01M 50/291; H01M 50/548; H01M 50/552; H01M 50/593

(57) ABSTRACT

A battery includes: a cell array including a plurality of cells, and a connection part that provides an electric connection between adjacent ones of the cells; and a case housing the cell array. The case includes a case body that the cell array is sandwiched and held in. In a cross-section of the case body, an opening portion that opens in a predefined direction (−Z-direction) is provided.

### CROSS-REFERENCE TO RELATED APPLICATION

This application claims priority to Japanese Patent Application No. 2024-039081 filed on Mar. 13, 2024, incorporated herein by reference in its entirety.

### BACKGROUND

### 1. Technical Field

The present disclosure relates to a power storage apparatus.

### 2. Description of Related Art

Japanese Unexamined Patent Application Publication (Translation of PCT application) No. 2023-502457 discloses a rectangular solid-shaped battery (power storage apparatus) in which a length L is 400 mm to 2500 mm and a ratio (L/H) of the length L relative to a width H is 4 to 21.

### SUMMARY

For the power storage apparatus as mentioned above, it is requested further to improve productivity such as assemblability of cells into a case and joining of the case.

The present disclosure is devised in order to solve the aforementioned problem, and an object thereof is to provide a power storage apparatus having improved productivity.

A power storage apparatus according to an aspect of the present disclosure includes: a cell array including a plurality of cells, and a connection part that provides an electric connection between adjacent ones of the cells; and a case housing the cell array. The case includes a first member that the cell array is sandwiched and held in. In a cross-section of the first member, an opening portion that opens in a predefined direction is provided.

By doing so, the cell array may be assembled from the opening portion of the first member of the case. Therefore, as compared with the case where the cell array is assembled so as to be inserted from an end part of a case that is formed of a tubular body, the cell array may be readily assembled with the case. Therefore, productivity of the power storage apparatus can be improved.

In an embodiment, in the cross-section of the first member, two wall surfaces provided to face each other, a connection portion that connects ends of the two wall surfaces, and the opening portion may be provided. On each of the two wall surfaces, a recess part that is provided to protrude toward the facing wall surface and has a bottom surface in contact with the cell array may be provided.

By doing so, since, by assembling the cell array with the first member, the cells are sandwiched by the bottom surfaces of the recess parts provided on the two facing wall surfaces, the first member may hold the cell array.

Furthermore, in an embodiment, the case may include a second member closing the opening portion of the first member to constitute a tubular body, a third member provided so as to close one end of the tubular body, and a fourth member provided so as to close another end of the tubular body.

By doing so, by closing the opening portions using the second member, the third member, and the fourth member in the state where the cell array is assembled with the first member, the whole periphery of the cell array may be covered by the case.

Furthermore, an embodiment may include: a cell array including a plurality of cells, and a connection part that provides an electric connection between adjacent ones of the cells; and a case housing the cell array. The case may include a tubular body enclosing a periphery of a surface of the cell array, the surface being along a longitudinal direction. The tubular body may be configured by folding a plate-shaped member so as to provide a wall surface facing each surface of the cell array along the longitudinal direction and joining one end of the plate-shaped member to a member on the other end side of the plate-shaped member.

By doing so, since the tubular body may be configured by joining the one end to the member on the other end side, increase of joined places may be restrained, and the joining may be performed without an influence on the cell array, for example, when a joined place of the one end to the member on the other end side is set to a position separate from the cell array. Therefore, productivity of the power storage apparatus can be improved.

According to the present disclosure, a power storage apparatus having improved productivity can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows views showing an example of a configuration of a battery which is a power storage apparatus according to the present embodiment;

FIG. 2 is a perspective view having cell arrays shown in FIG. 1 expanded;

FIG. 3 is an exploded perspective view of a cell included in the cell array shown in FIG. 1;

FIG. 4 is a view showing an example of a configuration of a case of the battery which is the power storage apparatus according to the present embodiment;

FIG. 5 is a cross-sectional view taken along the V-V line in FIG. 1; and

FIG. 6 shows views showing an example of a configuration of a battery which is a power storage apparatus according to a modification.

### DETAILED DESCRIPTION OF EMBODIMENTS

Hereafter, embodiments of the present disclosure will be described in detail with reference to the drawings. Note that the same or the corresponding portions in the figures are given the same signs and their description is not repeated. In the figures used below, among an X-axis, a Y-axis, and a Z-axis perpendicular to one another, the X-axis denotes a first in-plane direction of a battery (for example, a length direction), the Y-axis denotes a second in-plane direction of the battery (for example, a width direction), and the Z-axis denotes a height direction of the battery. Hereafter, directions indicated by the arrows of the X-axis, Y-axis, and Z-axis are given “+” and the reverse directions are given“−”.

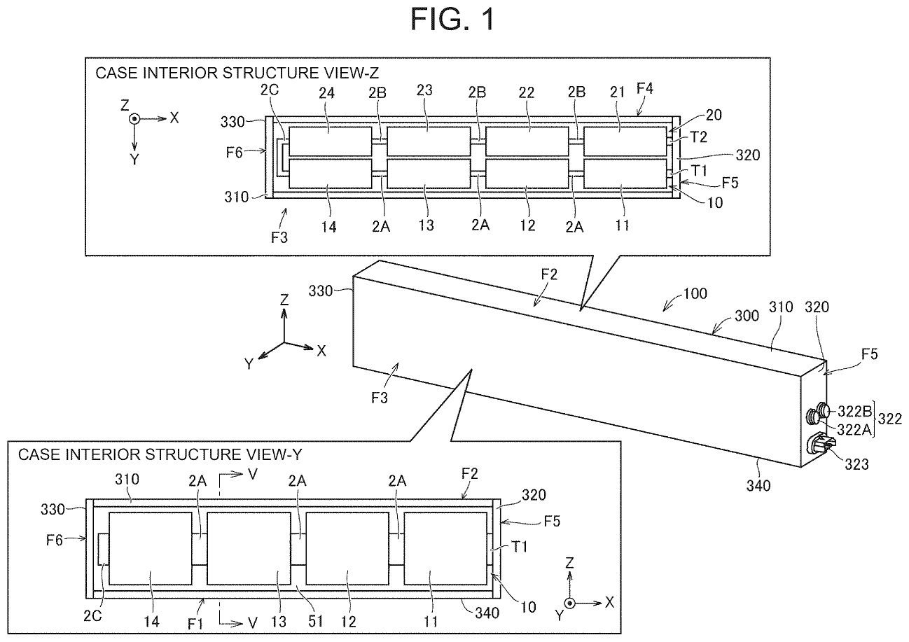

FIG. 1 shows views showing an example of a configuration of a battery 100 which is a power storage apparatus according to the present embodiment. In FIG. 1, “CASE INTERIOR STRUCTURE VIEW-Z” is a view of a case content as viewed from the +Z-side. In FIG. 1, “CASE INTERIOR STRUCTURE VIEW-Y” is a view of a case content as viewed from the +Y side.

For example, the battery 100 is a secondary battery such as a lithium-ion battery, a nickel-metal hydride battery, or a sodium ion battery. Examples of the lithium-ion battery include an LFP battery in which lithium iron phosphate is employed as a positive electrode active material, or a ternary battery in which nickel, manganese, and cobalt (NMC) are employed as a positive electrode active material. The type of the secondary battery may be any of a liquid-type secondary battery and an all-solid-state secondary battery. Details being mentioned later, the battery 100 includes a plurality of cells each functioning as a secondary battery. The battery 100 may only include the same type of cells (for example, only LFP batteries), or may include different types of cells (for example, LFP batteries and ternary batteries).

The battery 100 includes a case 300. The case 300 has a rectangular solid outer shape. The case 300 has a pair of surfaces F1, F2 (first facing surfaces) that face each other in the Z-direction, a pair of surfaces F3, F4 (second facing surfaces) that face each other in the Y-direction, and surfaces F5, F6 (end faces in the X-direction) that are positioned at the ends in the X-direction. Areas of the surfaces F1, F2 are smaller than areas of the surfaces F3, F4. A length (dimension in the X-direction) of the case 300 is larger than a width (dimension in the Y-direction) of the case 300. The length of the case 300 may be not less than 250 mm and not more than 5000 mm and, for example, about 1000 mm. The width of the case 300 may be not less than 10 mm and not more than 1250 mm and, for example, about 50 mm. A ratio of the length of the case 300 relative to the width of the case 300 may be not less than 4 and not more than 25. A height (dimension in the Z-direction) of the case 300 may be not less than 10 mm and not more than 1250 mm and, for example, about 100 mm. Note that the dimensions of the case 300 are not limited to those above.

The case 300 includes a case body 310, a first lid body 320, a second lid body 330, and a bottom part 340. The case body 310 is a housing in which openings are provided, for example, at an end part in the +X-direction, at an end part in the −X-direction, and at an end part in the −Z-direction. By the opening of the case body 310 at the end part in the −Z-direction being closed by the bottom part 340, a tubular body is formed, and cell arrays 10, 20 are housed inside the tubular body.

The first lid body 320 is a plate-shaped member (cover member) that has an outer shape corresponding to the opening of the case body 310 at the end part in the +X-direction, and closes the relevant opening. The second lid body 330 is a plate-shaped member (cover member) that has an outer shape corresponding to the opening of the case body 310 at the end part in the −X-direction, and closes the relevant opening.

The case body 310, the first lid body 320, the second lid body 330, and the bottom part 340 may be formed of an equivalent material, or may be formed of different materials. For the material that each of the case body 310, the first lid body 320, the second lid body 330, and the bottom part 340 is composed of, for example, a metal can be employed. The case 300 may be an aluminum-made case. Note that these materials can be modified as appropriate. For example, at least any of the first lid body 320, the second lid body 330, and the bottom part 340 may be formed of an insulating material.

The cell array 10 includes four cells 11 to 14 that can perform power storage, and three connection parts 2A each of which provides an electric connection between adjacent ones of the cells. In the case 300, the cells 11 to 14 are connected in a row along the X-direction.

The cell array 20 includes four cells 21 to 24 that can perform power storage, and three connection parts 2B each of which provides an electric connection between adjacent ones of the cells. In the case 300, the cells 21 to 24 are connected in a row along the X-direction.

As above, the cell array 10 and the cell array 20 are arranged in parallel along the X-direction. Each of the surfaces F1 to F4 of the case 300 has a shape extending along a joining direction of the cell arrays 10, 20 (the X-direction). The surfaces F5, F6 of the case 300 cover the respective end parts of the cell arrays 10, 20 in the X-direction.

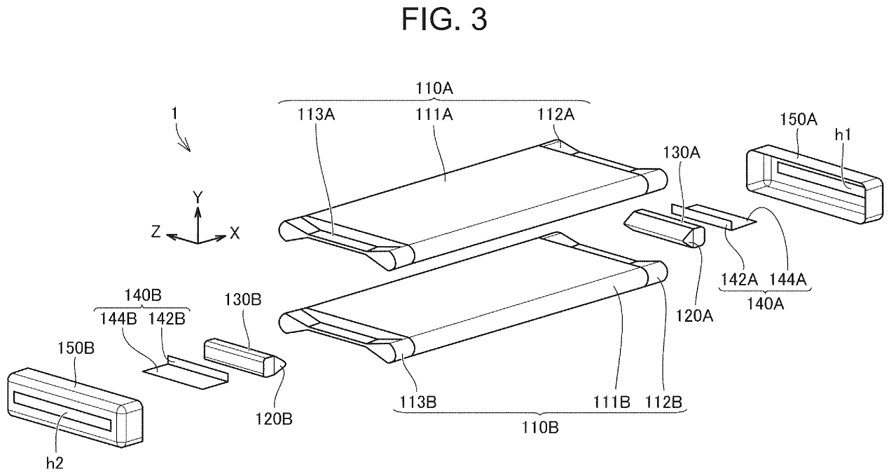

In the case 300 of the battery 100, the cell array 10 and the cell array 20 are electrically connected. Specifically, as shown in FIG. 1, in the case 300, an end part (cell 14) of the cell array 10 in the −X-direction and an end part (cell 24) of the cell array 20 in the −X-direction are electrically connected, for example, via a U-shaped connection part 2C. The connection part 2C basically has an equivalent structure to that of the connection part 2A or 2B except being formed to have a different shape from those of the connection parts 2A, 2B (each of the connection parts 2A, 2B has an I-shaped cross-section while the connection part 2C has a U-shaped cross-section). The connection part 2C may be an integrally molded article or may be a composite of a plurality of components separately molded. For example, the connection part 2C may be formed by connecting, via a conductive material (beam part), a protruding part 144B (FIG. 3) protruding from the cell 14 and a protruding part 144B (FIG. 3) protruding from the cell 24. Note that the protruding parts 144B are mentioned later.

The cell arrays 10, 20 are arranged such that positions of the cells and the connection parts are aligned. The cells 11, 12, 13, 14 included in the cell array 10 are arranged at positions respectively facing the cells 21, 22, 23, 24 included in the cell array 20.

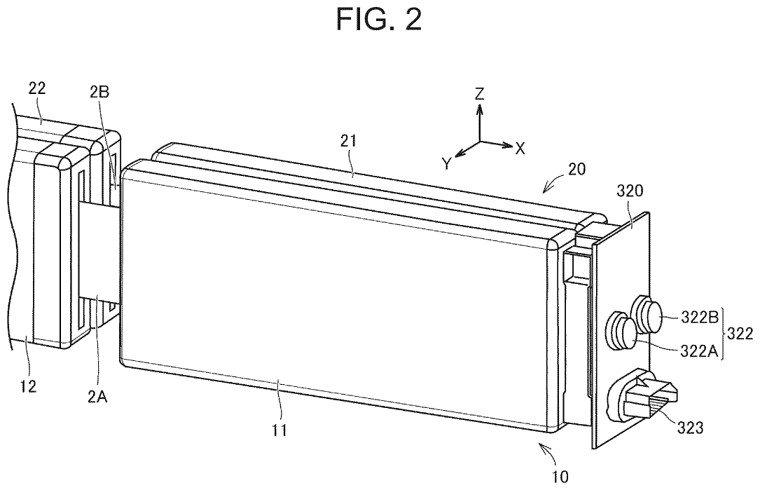

An end part (cell 11) of the cell array 10 in the +X-direction is connected to the first lid body 320 via a connection terminal T1. An end part (cell 21) of the cell array 20 in the +X-direction is connected to the first lid body 320 via a connection terminal T2. FIG. 2 is a perspective view having the cell arrays 10, 20 shown in FIG. 1 expanded.

The first lid body 320 has external terminals 322 and a connector 323. The external terminals 322 include an electrode tab 322A that is joined to the connection terminal T1 (FIG. 1) of the cell array 10 (for example, by laser welding), and an electrode tab 322B that is joined to the connection terminal T2 (FIG. 1) of the cell array 20 (for example, by laser welding). The electrode tabs 322A, 322B are electrically connected to the cells 11, 21, respectively. For example, each of the electrode tabs 322A, 322B may have an insulating seal structure with ceramics in the periphery of the electrode. In the present embodiment, the electrode tabs 322A, 322B function as a negative electrode tab and a positive electrode tab, respectively. Note that, not being limited to this, the electrode tab 322B may be the negative electrode tab and the electrode tab 322A may be the positive electrode tab with the polarity reversed.

For example, the connector 323 includes an output terminal for outputting, outside the case, detection signals indicating states (for example, temperatures of the cells) in the case 300 detected by one or more sensors in the case 300, and an input terminal through which control signals are input to one or more devices in the case 300 from the outside of the case. For example, in the case 300, temperature sensors may be provided for the individual cells.

In the present embodiment, the cell array 10 and the cell array 20 basically have equivalent configurations. Therefore, hereafter, when the cells 11 to 14, 21 to 24 are not distinguished, each of them is referred to as the “cell 1”, and when the connection parts 2A, 2B are not distinguished, each of them is referred to as the “connection part 2”.

FIG. 3 is an exploded perspective view of the cells included in the cell arrays 10, 20 shown in FIG. 1. Hereafter, structures of the cell 1 and the connection part 2 are described using FIG. 3. As shown in FIG. 3, the cell 1 has two wound bodies 110A, 110B, spacers 120A, 120B, terminal members 130A, 130B, and covers 150A, 150B.

The wound bodies 110A, 110B have applied parts 111A, 111B, electrode tabs 112A, 112B, electrode tabs 113A, 113B, respectively. Each of the applied parts 111A, 111B is a region of electrode foil in a positive electrode sheet or a negative electrode sheet, an active material layer being provided in the region. Each of the electrode tabs 112A, 112B, 113A, 113B is a region from which the electrode foil is exposed on the positive electrode sheet or the negative electrode sheet (unapplied part in which the active material layer is not provided). The electrode tabs 112A, 112B are positioned at end parts of the wound bodies 110A, 110B in the +X-direction, respectively. The electrode tabs 113A, 113B are positioned at end parts of the wound bodies 110A, 110B in the −X-direction, respectively.

The electrode tab 112A and the electrode tab 112B are arranged so as to be positioned to face each other in the Y-direction, and between these electrode tab 112A and electrode tab 112B, the spacer 120A and the terminal member 130A are provided. The electrode tab 113A and the electrode tab 113B are arranged so as to be positioned to face each other in the Y-direction, and between these electrode tab 113A and electrode tab 113B, the spacer 120B and the terminal member 130B are provided.

Each of the spacers 120A, 120B includes an insulating material (for example, a synthetic resin), and has insulation. Each of the spacers 120A, 120B has a shape that becomes larger in dimension in the Y-direction as separating from the applied part 111A, 111B. The terminal member 130A is connected to an end surface of the spacer 120A in the +X-direction. The terminal member 130B is connected to an end surface of the spacer 120B in the −X-direction. Each of the terminal members 130A, 130B includes a conductive material (for example, a metal such as aluminum), and has conductivity. The wound body 110A and the wound body 110B are joined to each other via the terminal members 130A, 130B (for example, by laser welding).

Each of the current collector terminals 140A, 140B is a component constituting a part of the connection part 2. The current collector terminals 140A, 140B have support parts 142A, 142B and protruding parts 144A, 144B, respectively. One of the current collector terminals 140A, 140B functions as a positive electrode current collector terminal, and the other functions as a negative electrode current collector terminal. As an example, the positive electrode current collector terminal is formed of aluminum, and the negative electrode current collector terminal is formed of copper.

Each of the current collector terminals 140A, 140B is formed into an L-shape. Each of the support parts 142A, 142B is formed into a plate shape on a Y-Z-plane, and each of the protruding parts 144A, 144B is formed into a plate shape on an X-Z-plane. The support part 142A and the protruding part 144A may be separately formed and joined, or may be shaped by folding processing in the integrated state. Likewise, the support part 142B and the protruding part 144B may be separately formed and joined, or may be shaped by folding processing in the integrated state. The support part 142A is joined to an end surface of the terminal member 130A in the +X-direction (for example, by laser welding). The support part 142B is joined to an end surface of the terminal member 130B in the −X-direction (for example, by laser welding).

The cover 150A covers an end part of the cell 1 in the +X-direction (including the electrode tabs 112A, 112B). Note that a through-hole h1 for the protruding part 144A is provided in the cover 150A. The protruding part 144A protrudes in the +X-direction of the cell 1 through the through-hole h1. Moreover, the cover 150B covers an end part of the cell 1 in the −X-direction (including the electrode tabs 113A, 113B). Note that a through-hole h2 for the protruding part 144B is provided in the cover 150B. The protruding part 144B protrudes in the −X-direction of the cell 1 through the through-hole h2.

At the connection part 2, out of the two adjacent cells 1, the protruding part 144A of one cell 1 is joined to the protruding part 144B of the other cell 1 (for example, by laser welding). The welded part may be protected by a tape or the like. Moreover, laminate films (not shown) are provided on the surfaces of the two wound bodies 110A, 110B.

Note that the aforementioned configuration is merely an example of the configuration of the cell 1, and can be modified as appropriate. For example, the number of wound bodies included in the cell 1 is not limited to two and may be one or three or more. Moreover, as the electrode body, in place of the wound body, there may be employed a stacked body (for example, a stacked body having positive electrode sheets and negative electrode sheets stacked via separators).

For the battery 100 having the configuration as above, it is requested further to improve productivity such as assemblability of the cell arrays 10, 20 with the case 300 and joining of the case 300. In particular, since the cell arrays 10, 20 have rectangular shapes, when the cell arrays 10, 20 are inserted into the tubular body in the state where the tubular body is formed of the case body 310 and the bottom part 340, it is requested to improve the assemblability due to contact of the cell arrays 10, 20 with the inner side of the tubular body and the similar cause.

Therefore, in the present embodiment, the case 300 includes the case body 310 that sandwiches and holds the cell arrays 10, 20, and in a cross-section of the case body 310, an opening portion that opens in a predefined direction is provided. More specifically, in the cross-section of the case body 310, the two surfaces F3, F4 provided to face each other, a connection portion that connects ends of the two surfaces F3, F4, and the opening portion are provided. Furthermore, on each of the two surfaces F3, F4, a recess part that is formed to protrude toward the facing surface and has a bottom surface in contact with the cell arrays 10, 20 is provided.

By doing so, the cell arrays 10, 20 can be assembled from the opening portion of the case body 310. Therefore, they can be housed in the case 300 without being inserted from an end part of the tubular body. Thereby, the cell arrays 10, 20 can be readily assembled with the case 300. Furthermore, when the cell arrays 10, 20 are sandwiched by the bottom surfaces of the recess parts provided on the two facing surfaces F3, F4 by assembling the cell arrays 10, 20 with the case body 310, the case body 310 can hold the cell arrays 10, 20.

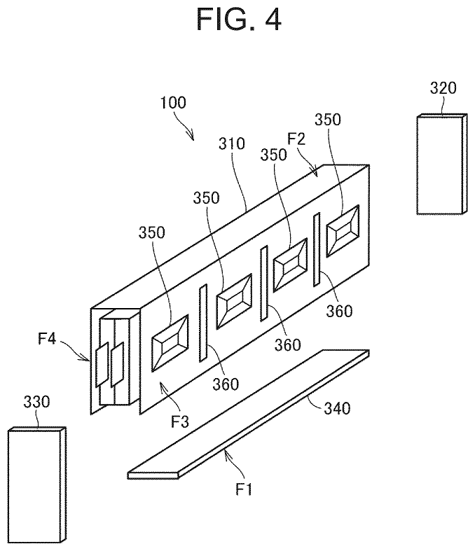

FIG. 4 is a view showing an example of the configuration of the case 300 of the battery 100 which is a power storage apparatus according to the present embodiment.

As shown in FIG. 4, on each of the surfaces F3, F4 which are two facing wall surfaces in the case body 310, a plurality of (in the present embodiment, four, for coinciding with the number of the cells) recess parts 350 is formed, each formed by a predefined region (for example, a rectangular region) being recessed inward (to the cell arrays 10, 20 side), along the longitudinal direction of the surfaces F3, F4. More specifically, on the surface F3, four recess parts 350 formed by rectangular regions being recessed in the −Y-direction are formed in the longitudinal direction of the case body 310. Furthermore, on the surface F4, four recess parts 350 formed by rectangular regions being recessed in the +Y-direction are formed in the longitudinal direction of the case body 310.

In each of the surfaces F3, F4, a plurality of rectangular slits 360 is provided between the adjacent recess parts 350. Each slit 360 is formed so as to have a predefined length with the Z-direction being as its longitudinal direction. The slits 360 are provided at positions facing the connection parts 2B between the cells in the cell arrays 10, 20.

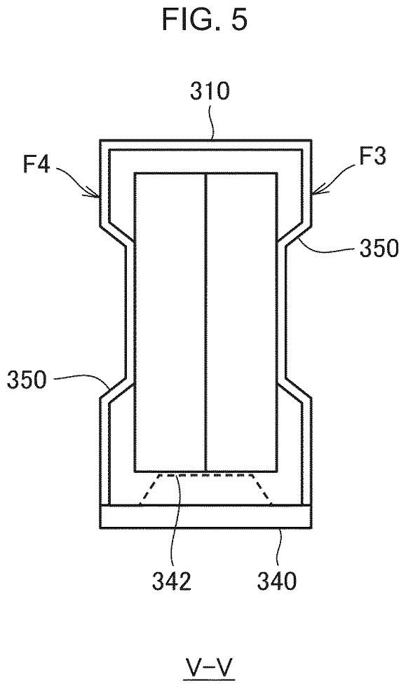

FIG. 5 is a cross-sectional view taken along the V-V line in FIG. 1. As shown in FIG. 5, the bottom surface of the recess part 350 formed on the surface F3 and the bottom surface of the recess part 350 formed on the surface F4 take positional relation of facing each other. Further, a distance (distance in the Y-direction) between the bottom surfaces is set to a length at which the bottom surface of the recess part of the surface F3 and the bottom surface of the recess part of the surface F4 are in contact with the cell arrays 10, 20 when the cell arrays 10, 20 are assembled with the case body 310. Therefore, when the cell arrays 10, 20 are assembled with the case body 310, the bottom surface of the recess part 350 of the surface F3 and the bottom surface of the recess part 350 of the surface F4 are to sandwich the cell arrays 10, 20, and the cell arrays 10, 20 are to be held in the case body 310.

The opening portion of the case body 310 in the −Z-direction is closed by the bottom part 340, an opening portion of the case body 310 in the +X-direction is closed by the first lid body 320, an opening portion of the case body 310 in the −X-direction is closed by the second lid body 330, and thereby, the case 300 is configured.

Note that while a case where the surface F2 which is a connection part connecting the surfaces F3, F4 which are two wall surfaces is configured by a flat plane has been described as an example, on the surface F2, convex and concave portions may be formed such that the surface area increases more than in the case of the configuration by the flat plane, or the surface F2 may be configured by a curved surface convex in the +Z-direction or the −Z-direction. By doing so, the surface area on the surface F2 can be increased to improve heat radiation performance of the battery 100.

Furthermore, while there is described as an example the case where the bottom part 340 is configured by a flat plane, as indicated by the broken line in FIG. 5, a recess part 342 recessing inward (to the cell array 10, 20 side) may be formed on the bottom part 340. By doing so, positions of the cell arrays 10, 20 in the −Z-direction can be restricted.

Operation of the battery 100 having the structure as above is described. Since the cross-section of the case body 310 of the case 300 has the opening portion opening in the predefined direction (−Z-direction), the cell arrays 10, 20 can be assembled with the case body 310 without the cell arrays 10, 20 being inserted from the opening portion in the +X-direction or the −X-direction. After the cell arrays 10, 20 are assembled with the case body 310, the bottom surfaces of the recess parts 350 provided on the surfaces F3, F4 of the case body 310 sandwich the surfaces of the cell arrays 10, 20 in the Y-direction, and thereby, the cell arrays 10, 20 are restricted from moving in the case body 310 in the Y-direction and the Z-direction.

As above, with the battery 100 which is a power storage apparatus according to the present embodiment, the cell arrays 10, 20 can be assembled from the opening portion of the case body 310 of the case 300. Therefore, the cell arrays 10, 20 can be housed in the case 300 without being inserted from an end part of the case body 310 in the X-direction. Thereby, the cell arrays 10, 20 can be readily assembled with the case 300. Therefore, assemblability of the cell arrays 10, 20 with the case 300 can be improved. Accordingly, a power storage apparatus having improved productivity can be provided.

Furthermore, by assembling the cell array 10 with the case body 310, the bottom surfaces of the recess parts 350 provided on the two surfaces F3, F4 can be in contact with the cell arrays 10, 20 to hold the cell arrays 10, 20. Therefore, since a component for holding the cell arrays 10, 20 does not need to be separately configured, increase of the number of components of the battery 100 can be restrained.

Furthermore, by closing, in the state where the cell arrays 10, 20 are assembled with the case body 310, the opening portion of the case body 310 using the first lid body 320, the second lid body 330, and the bottom part 340, the battery 100 which is the power storage apparatus can be formed.

Furthermore, providing the slits 360 enables inflow of air into the battery 100 and outflow of air from the battery 100, and heat radiation performance can be improved. Furthermore, when convex and concave portions are provided on the surface F1 and/or the surface F2, the surface area can be increased thereby to improve the heat radiation performance.

Hereafter, modifications are described.

While in the aforementioned embodiment, there has been described the configuration in which the bottom part 340 closes the opening of the case body 310 in the −Z-direction, there may be employed a configuration in which the bottom part 340 is omitted.

Furthermore, while in the aforementioned embodiment, there has been described the configuration in which the bottom part 340 closes the opening of the case body 310 in the −Z-direction, there may be employed a configuration in which when the cell arrays 10, 20 is held by the case body 310, the bottom part 340 and an end part of at least any wall surface (end part in the −Z-direction) of the two surfaces F3, F4 of the case body 310 are joined. Moreover, not being limited to continuous welding with laser for the joined portion, there may be employed joining with an adhesive agent or by spot welding.

Furthermore, while in the aforementioned embodiment, there has been described as an example the configuration in which the cell arrays 10, 20 are sandwiched in the Y-direction, there may be employed, for example, a configuration of sandwiching them in the X-direction.

Furthermore, while in the aforementioned embodiment, there has been described as an example the configuration in which the opening is formed in the −Z-direction of the case body 310 to improve assemblability of the cell arrays 10, 20 to improve productivity of the battery 100, the configuration to improve productivity of the battery 100 is not limited to forming the opening in the −Z-direction. For example, the case body 310 may be configured so as to include a tubular body enclosing surfaces of the cell arrays 10, 20, the surfaces being along the longitudinal direction. In this case, the tubular body is configured by folding a plate-shaped member so as to enclose the cell arrays 10, 20 and joining one end of the plate-shaped member to a member on the other end side.

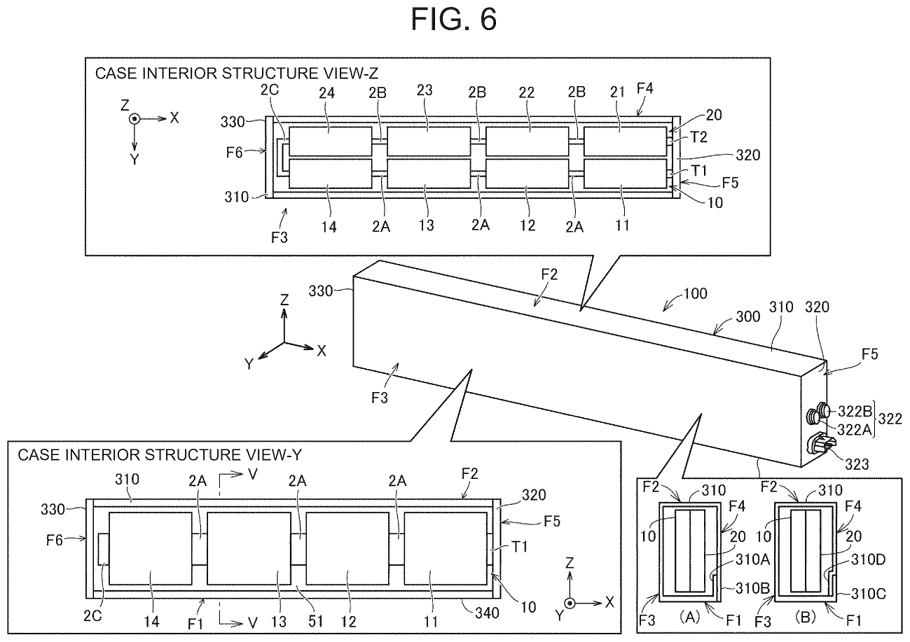

FIG. 6 shows views showing an example of a configuration of the battery 100 that is a power storage apparatus according to a modification. As compared with the battery 100 shown in FIG. 1, the battery 100 shown in FIG. 6 is different in configuration of the case 300. Since the configuration except that of the case 300 is similar to that of the battery 100 shown in FIG. 1, its detailed description is not repeated. Note that (A) and (B) of FIG. 6 are views of the case content as viewed from the +X-direction.

As shown in FIG. 6, in this modification, the case 300 includes the case body 310, the first lid body 320, and the second lid body 330. For example, the case body 310 is a housing having openings at the end part in the +X-direction and the end part in the −X-direction. The case body 310 forms a tubular body, and the cell arrays 10, 20 are housed inside the tubular body. Since the first lid body 320 and the second lid body 330 shown in FIG. 6 have the similar configurations to those of the first lid body 320 and the second lid body 330 shown in FIG. 1, their detailed description is not repeated. The case body 310, the first lid body 320, and the second lid body 330 may be formed of an equivalent material, or may be formed of different materials. For the material that each of the case body 310, the first lid body 320, and the second lid body 330 is composed of, for example, a metal can be employed. The case 300 may be an aluminum-made case. Note that these materials can be modified as appropriate. For example, at least any of the first lid body 320 and the second lid body 330 may be formed of an insulating material.

The case body 310 includes the tubular body that encloses surfaces of the cell arrays 10, 20 along the longitudinal direction (that is, surfaces in the Z-direction and surfaces in the Y-direction). The tubular body is formed by folding a plate-shaped member so as to enclose the periphery of the cell arrays 10, 20 around the X-axis. Then, one end of the folded plate-shaped member is joined to the other end thereof to configure the tubular body.

More specifically, as shown in (A) of FIG. 6, the tubular body is configured by the plate-shaped member being folded at the right angles with a boundary line between the surface F2 and the surface F4, a boundary line between the surface F2 and the surface F3, a boundary line between the surface F1 and the surface F3, and a boundary line between the surface F1 and an excess portion being as folding places. Further, one end of the plate-shaped member (that is, the one end of the surface F4 in the −Z-direction) is joined to the boundary portion between the surface F1 and the excess portion.

By doing so, since the tubular body can be configured by the one end of the plate-shaped member (the one end of the surface F4) being joined to a member (the excess portion) on the other end side, increase of joined places can be restrained, and the joined place of the one end to the member on the other end side can be set to a position separate from the cell arrays 10, 20. Therefore, the joining can be performed without an influence on the cell arrays 10, 20. Thereby, productivity of the battery 100 which is the power storage apparatus can be improved.

Note that the joined place of the one end to the member on the other end side on the case body 310 is not limited to the joined place shown in (A) of FIG. 6. For example, as shown in (B) of FIG. 6, there may be employed a configuration in which, with positional relation between the excess portion and the surface F4 being reversed to the positional relation shown in (A) of FIG. 6, the excess portion is set to be positioned outward (in the −Y-direction) of the one end of the surface F4, and the one end of the surface F4 is folded such that the plane of the excess portion and the surface F4 (except the one end in the −Z-direction) are positioned on an equivalent plane and a step portion is formed at the one end of the surface F4. In this case, the one end of the excess portion is joined to the step portion of the surface F4.

By doing so, since the tubular body can be configured by the one end of the plate-shaped member (the one end of the excess portion) being joined to the member on the other end side (step portion of the surface F4), increase of joined places can be restrained, and the joined portion of the one end to the member on the other end side can be set to a position separate from the cell arrays 10, 20. Therefore, the joining can be performed without an influence on the cell arrays 10, 20. Thereby, productivity of the battery 100 which is the power storage apparatus can be improved.

Note that all of or a part of the aforementioned modifications may be combined and implemented as appropriate.

It should be construed that the embodiment disclosed here is exemplary and not restrictive in all respects. The scope of the present disclosure is indicated by the claims, not by the aforementioned description, and is intended to include all the modifications within the scope and spirit of the claims and the equivalents.

What is claimed is:

1. A power storage apparatus comprising:
a cell array including
a plurality of cells, and
a connection part that provides an electric connection between adjacent ones of the cells; and
a case housing the cell array, wherein:
the case includes a first member that the cell array is sandwiched and held in; and
in a cross-section of the first member, an opening portion that opens in a predefined direction is provided.

2. The power storage apparatus according to claim 1, wherein:
in the cross-section of the first member, two wall surfaces provided to face each other, a connection portion that connects ends of the two wall surfaces, and the opening portion are provided; and
on each of the two wall surfaces, a recess part that is provided to protrude toward the facing wall surface and has a bottom surface in contact with the cell array is provided.

3. The power storage apparatus according to claim 1, wherein
the case includes
a second member closing the opening portion of the first member to constitute a tubular body,
a third member provided so as to close one end of the tubular body, and
a fourth member provided so as to close another end of the tubular body.

4. A power storage apparatus comprising:
a cell array including
a plurality of cells, and
a connection part that provides an electric connection between adjacent ones of the cells; and
a case housing the cell array, wherein:
the case includes a tubular body enclosing a periphery of a surface of the cell array, the surface being along a longitudinal direction; and
the tubular body is configured by folding a plate-shaped member so as to provide a wall surface facing each surface of the cell array along the longitudinal direction and joining one end of the plate-shaped member to a member on the other end side of the plate-shaped member.
